(19) United States
(12) Patent Application Publication
(10) Pub. No.: US 2024/0202668 A1
(43) Pub. Date: Jun. 20, 2024

(54) EXECUTION OF FORECASTING MODELS GENERATED BASED ON PLANNING CALENDARS

(71) Applicant: SAP SE, Walldorf (DE)

(72) Inventors: Bertrand Lamy, Paris (FR); Marc Bizeul, Puteaux (FR); Savaneary Sean, Bussy Saint Georges (FR)

(21) Appl. No.: 18/082,049

(22) Filed: Dec. 15, 2022

(51) Int. Cl. G06Q 10/109; G06Q 10/04

(52) U.S. Cl. CPC G06Q 10/109; G06Q 10/04

(57) ABSTRACT

The present disclosure relates to computer-implemented methods, software, and systems for identifying cycle patterns in data observations collected as time series based on a planning calendar with a time hierarchy. Time series can include data observations associated with a respective date. Model variables derived based on each date associated with each data observation can be determined. The model variables can map a date of a data observation to an occurrence of the date according to a time hierarchy of a planning calendar. The time hierarchy can include periods of sub-periods as a hierarchy level, where each period is defined to comprise a number of sub-periods based on a week-based pattern of the planning calendar. A predictive model is generated for a predicted variable identified at the data observations based on the model variables. The predictive model is executed to predict values for the predicted variable over a time horizon.

### TECHNICAL FIELD

The present disclosure relates to computer-implemented methods, software, and systems for data processing.

### BACKGROUND

Customers' needs are transforming and imposing higher requirements for process execution, lifecycle management, and technical landscape that also support high availability to access software resources provided by an underlying software platform.

Software applications, systems, devices, and processes, among other examples, can be associated with data monitoring and prediction of execution results, process outcome, and/or performance. Data observations from various sources can be observed to generate prediction models that can be used in the context of data simulation and automation. Time can be a crucial factor and a variable for time series analysis.

### SUMMARY

Implementations of the present disclosure are generally directed to a computer-implemented method for identifying cycle patterns in data observations collected as time series based on a planning calendar with a time hierarchy identifying periods of sub-periods (for example, weeks) as a hierarchy level in the time hierarchy.

In some implementations, a computer-implemented method can include: obtaining, as an obtained time series, a time series comprising data observations, each data observation associated with a respective date; determining model variables derived based on each date associated with each data observation, wherein the model variables map a date of a data observation to an occurrence of the date according to a time hierarchy of a planning calendar, wherein the time hierarchy comprises periods of sub-periods as a hierarchy level, wherein each period is defined to comprise a number of sub-periods based on a week-based pattern of the planning calendar, and wherein a sub-period comprises a number of consecutive days of a year; generating a predictive model for a predicted variable identified at the data observations based on the model variables, wherein the predictive model identifies recurring data patterns at the time series for the predicted variable within the periods of the time hierarchy; and executing the predictive model to predict, as predicted values, values for the predicted variable over a time horizon.

In some instances, the model variables are determined for each combination of hierarchy levels of the planning calendar, the hierarchy levels comprising a year, an aggregation period, a period, a sub-period, and a day.

In some instances, the planning calendar is a calendar defined to comprise a same number of days in a hierarchy level of the time hierarchy, and wherein each sub-period within a period of the time hierarchy is defined to start on a same weekday of the Gregorian calendar.

In some instances, a first period of sub-periods is a period of weeks within the time hierarchy of the planning calendar, wherein the first period comprises a different number of weeks compared to a second period of weeks as sub-periods and a third period of weeks as sub-periods, the second period of weeks and the third period of weeks being defined within the time hierarchy of the planning calendar.

In some instances, the planning calendar comprising a 4-4-5 week-based pattern as the pattern of the planning calendar, wherein the 4-4-5 week-based pattern defines a repetitive sequence of number of weeks for each consecutive period in the time hierarchy of the planning calendar.

In some instances, each period of sub-periods comprises a same number of sub-periods as the week-based pattern of the planning calendar.

In some instances, the obtained time series comprise data identifying a position of a respective date of a data observation within a hierarchy of a Gregorian calendar, wherein the Gregorian calendar is defined to comprise hierarchy levels comprising calendar year, calendar quarter, calendar month as a period comprising a respective number of days.

In some instances, the method can include providing the predicted values for the predicted variable as input for executing a process for scheduling resource consumption over the time horizon.

In some instances, the predictive model is generated based on a plurality of predictor values comprising the model variables as variables for prediction and one or more additional variables as one or more respective predictors to support prediction of values for the predicted variable.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The subject matter described in this specification can be implemented to realize one or more of the following advantages. Forecasting based on executing prediction models generated based on planning calendars can improve the application of the forecasting in system processes and production set-ups. Such prediction models can be adapted for specific technical context of implementation processes and scenarios related to different business operations. Further, using prediction that relies on specific calendars (for example, business calendars that match a process defined at a system or network of applications associated with operations, such as business processes, transportation and logistics, supply and demand of physical entities, and network load, among other example technical implementations). Based on such exclusion, forecasting can be performed more accurately by identifying time series patterns based on a calendar that matches a practical application of the calendar, for example, in a technical context of a configured software process, system, business process execution, among other examples. Further, providing forecasts based on such models can allow for generating user data that can be plotted and/or presented to users in different context to allow for easy recognition of patterns in a user friendly way that improves the user experience.

The details of one or more implementations of the present disclosure are set forth in the accompanying drawings and the description below. Other features and advantages of the present disclosure will be apparent from the description, drawings, and the claims.

### BRIEF DESCRIPTION OF DRAWINGS

FIG. 1 is a block diagram depicting an example computer-implemented system that can execute implementations of the present disclosure in accordance with implementations of the present disclosure.

FIG. 2A is a table diagram depicting an example of a forecasting resulting from a time series analysis and time hierarchy that can be used for the analysis.

FIG. 2B is a table diagram depicting example model variables that can be used for generating a predictive model for prediction based on data observations in accordance with implementations of the present disclosure.

FIG. 2C includes graphs as examples for comparison of cyclic patterns identified based on different calendars.

FIG. 3 is a block diagram presenting an example user interface for defining a week-based pattern of a planning calendar to be used for generating a predictive model in accordance with implementations of the present disclosure.

FIG. 4 is an example of a process 400 to identify recurring data patterns in time series and generate forecasts based on the identified data patterns in accordance with implementations of the present disclosure.

FIG. 5 is a block diagram of a system environment for executing prediction services based on a time horizon defined according to a calendar in accordance with implementations of the present disclosure.

FIG. 6 is a schematic diagram of an example computer system that can be used to execute implementations of the present disclosure.

Like reference numbers and designations in the various drawings indicate like elements.

### DETAILED DESCRIPTION

The present disclosure describes various tools and techniques for identifying data patterns within periods of a time hierarchy of a planning calendar, where the data patterns are identified based on data observations collected as time series. The identification of data patterns in data observations can be during the execution of predictive services based on forecasting models for predicting future expected data observations. The result from such predictive services can be used for automating process executions, planning and forecasting executions, performing system maintenance based on predicted resource demand and/or supply, adjustments to sensors and devices in physical spaces, or defining device work schedules, among other example of utilization.

In some instances, time series analysis can be used in the context of various forecasting tasks and processes defined in organizations, for example, forecasting production units, sales, and estimating prices, among other example organizational processes. Further, forecasting can be used in the context of automating process execution based on accurate prediction of process execution results, scheduling of operations of devices, systems and environments, or other performance prediction executions.

In some instances, predictive technology can be combined with planning activities to support planning users in generating useful predictions that can be implemented in different contexts or environments. Time series analysis technologies and methods support the analysis of data pointers (measure data) that is associated with a time/date aspect. A predictive model can be derived based on such time series including dates and measures. In some instances, prediction methods such as regressions, correlation, or neural network implementations, among other example methods can be used to identify contributors from indicators in the time series data. In some instances, the indicators can be determined based on a definition of a user-provided calendar and/or a time hierarchy. For example, an indicator can be defined to correspond to different categories of a time dimension associated with the time series. For example, based on the Gregorian calendar, a contributor that contributes to a forecasting model can be determined based on an analysis of indicators such as, a day of a week, a week of a month, a day of a month, a month of the year, a week of the year, a month of an aggregation period (e.g., quarter or half a year), other. For example, if the indicator “day of week” is contributive in the forecasting model, this means that a weekly cycle is detected in the observations for the measures (for example, sales volumes, demanded quantities, and other).

In some instances, an organization can rely on a planning software and/or a planning system (for example, on-premise or cloud applications and systems) to perform forecasting and to implement predicted results into organizational processes (for example, business processes, resource scheduling, activities, and execution automation). While the disclosure is described with respect to a planning calendar, business calendar, process, resource scheduling, activities, and automated executions, the describe concept has applicability in other technological areas using time series such as in the context of manufacturing machines operations, construction work process planning, freight processes of goods, cloud service provisioning, system infrastructure instantiation and maintenance, upgrade process triggering, among other example operations.

In some instances, an organization may rely on their own time dimension when implementing organizational processes. For example, users of planning software of a given organization can define a business calendar with a time hierarchy that corresponds to the specifics of their processes. For example, a definition of such time dimension can be made to define that each quarter of each year comprises 3 periods of a number of weeks, where the weeks within subsequent periods are in a week-based pattern such as that every three consecutive periods include the sequence of 4, 4, and 5 weeks (for example, called a 4-4-5 week-based pattern for a time hierarchy of the business calendar). For example, such a calendar can correspond to actual business execution and processes and may be used as a planning calendar for the organizational process executions.

In some instances, multiple planning calendars can be defined with respect to different requirements of organizations, where such planning calendars can be different from the Gregorian calendar. In some instances, such planning calendars can be organized according to a time hierarchy including hierarchy levels, where each hierarchy level defines the same number of days as a time granularity. The hierarchy can define periods of sub-periods (for example, weeks), where each sub-period (for example, a week) can be a sub-period of predetermined number of days. For example, a week can be defined to include 7 days. In some instances, each sub-period can start on the same first day (for example, each week starts on Monday or Sunday). In such way, a period (or a sub-period) of a calendar (for example, a business calendar different from the Gregorian calendar) can include days from two consecutive months defined according to the Gregorian calendar.

In some instances, a planning calendar can be defined to have hierarchy levels including a year, a quarter, a period, a week, and a day. Each period can be defined to comprise a number of weeks based on a week-based pattern of the planning calendar. For example, a week-based pattern applied in a planning calendar can include the 4-4-5 patterns, where consecutive periods of a quarter (and inherently of a year) include consecutively a first, a second, and a third period, where the first period has 4 weeks, the second period has 4 weeks, and the third period has 5 weeks (forming a quarter of three periods). Another example of a week-based pattern that can be applied in a planning calendar can be the 5-4-4 patterns, where the first period has five weeks, the second period has 4 weeks, and the third period has 4 weeks, and then the week-based pattern is repeated. These example week-based patterns are applied for every consecutive three periods, where other example week-based patterns can be further defined that spread through less or more than three periods.

As another example, a planning calendar can be defined to have a week-based pattern that defines that each period of the time hierarchy of the planning calendar will have the same number of weeks. Thus, for a Gregorian calendar year of fifty-two (52) weeks spread into twelve months, a planning calendar including thirteen (13) periods of four (4) weeks can be defined, or a planning calendar including four (4) periods of thirteen (13) weeks can be defined. In some instances, a planning calendar can be custom defined by a user, for example, based on evaluation of historic data acquired from execution of processes at an organization. In some instances, a user of a forecasting application or a predictive service can be provided with tools and techniques to define their own time dimension, as a flexible time dimension that may not be related to the Gregorian calendar and rely on periods as a hierarchy level, rather than a month (as in the Gregorian calendar).

In some instances, if processes of an organization are planned and executed according to a planning calendar particular to the organization, it may be relevant that the time series analysis is performed according to a time dimension synchronized with the planning calendar or according to a different planning calendar that the organization would like to implement (for example, switching between business calendars). By executing prediction in accordance with a particular planning calendar, time patterns in the data observations collected for executed processes would be identified for the periods of the particular planning calendar. In some instances, if the observations are analyzed according to different calendars, different time patterns can be identified. If an organization wants to implement planning processes according to a first planning calendar, the first planning calendar can be used for generating a predictive model and such model can be executed to identify time patterns and to project values for a time horizon on the first planning calendar.

In some instances, when planning is performed according to a planning calendar (for example, a business calendar rather than the Gregorian calendar), a prediction or forecast can be adjusted to the planning calendar. In some instances, a predictive model identifying patterns of data point occurrences can be generated that is aligned with the planning calendar used by a particular user (for a given organization and/or a user case). Thus, predictive technology may be adjusted to address such needs and to adopt the time definition as provided in the planning calendar to provide predictions based on time series analyses aligned with that time definition. For example, rather than providing a prediction that identifies that “the time series, when observed on a weekly basis, follows a recurring pattern every month” (that prediction would be aligned to a Gregorian calendar identifying calendar months as periods), to provide a prediction aligned with the selected planning calendar, such as “The time series, when observed on a weekly basis, follows a recurring pattern every period”.

In some instances, predictive models can be trained to adopt the time hierarchy of the planning calendar (for example, based on a request or automatically identifying a planning calendar of relevance) and apply it to identify data cycles based on weeks, periods, quarters, and/or years.

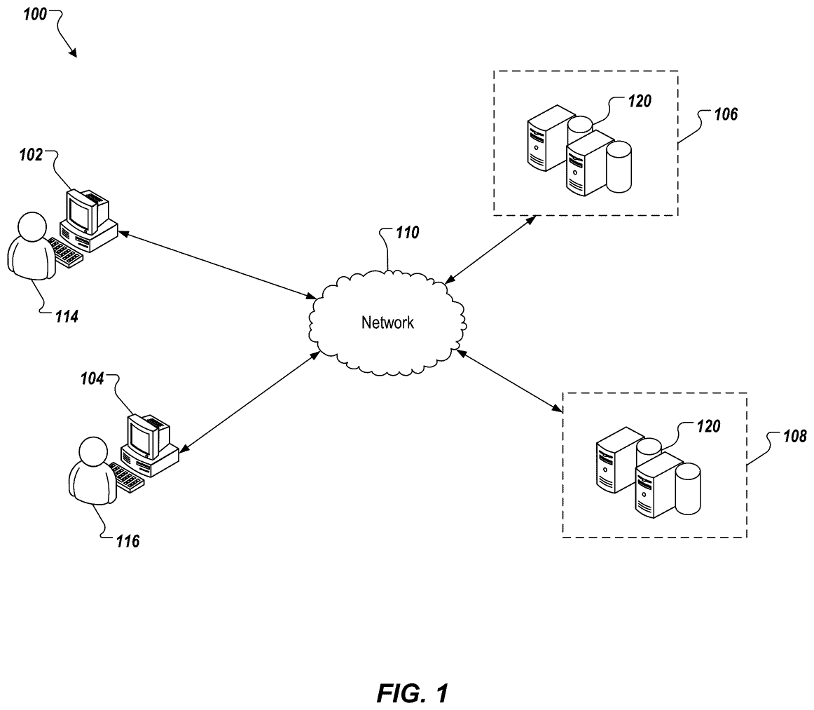

FIG. 1 is a block diagram depicting an example computer-implemented system 100 that can execute implementations of the present disclosure. In the depicted example, the example system 100 includes a client device 102, a client device 104, a network 110, a cloud environment 106, and a cloud environment 108. The cloud environment 106 may include one or more server devices and databases (for example, processors, memory). In the depicted example, a user 114 interacts with the client device 102, and a user 116 interacts with the client device 104.

In some examples, the client device 102 and/or the client device 104 can communicate with the cloud environment 106 and/or cloud environment 108 over the network 110. The client device 102 can include any appropriate type of computing device, for example, a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (for example, a public switched telephone network (PSTN)), or an appropriate combination thereof connecting any number of communication devices, mobile computing devices, fixed computing devices and server systems.

In some implementations, the cloud environment 106 includes at least one server and at least one data store 120. In the example of FIG. 1, the cloud environment 106 is intended to represent various forms of servers including, but not limited to, a web server, an application server, a proxy server, a network server, and/or a server pool. In general, server systems accept requests for application services and provide such services to any number of client devices (for example, the client device 102 over the network 110).

In accordance with implementations of the present disclosure, and as noted above, the cloud environment 106 can host applications and databases running on the host infrastructure. In some instances, the cloud environment 106 can include multiple cluster nodes that can represent physical or virtual machines that can represent web node clusters. A hosted application and/or service can run on VMs hosted on cloud infrastructure.

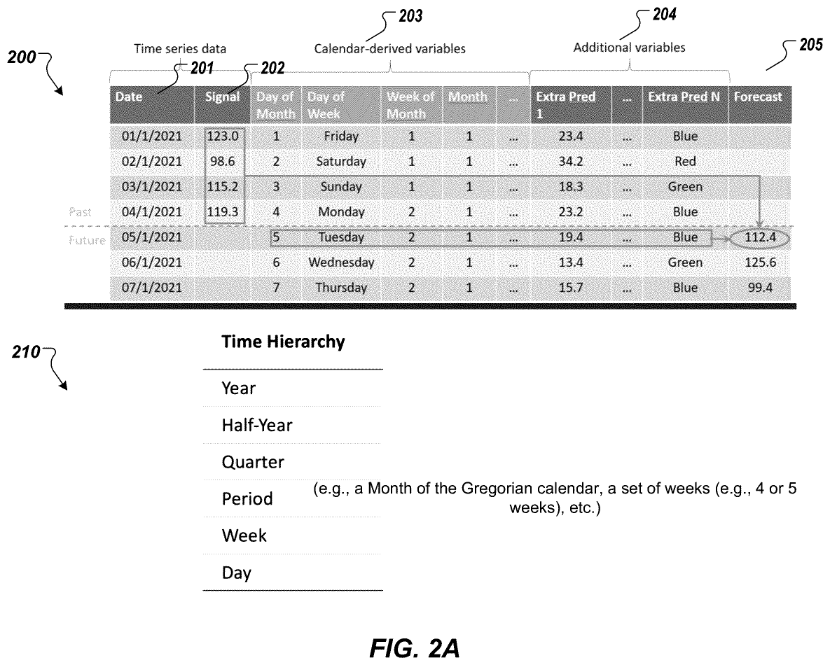

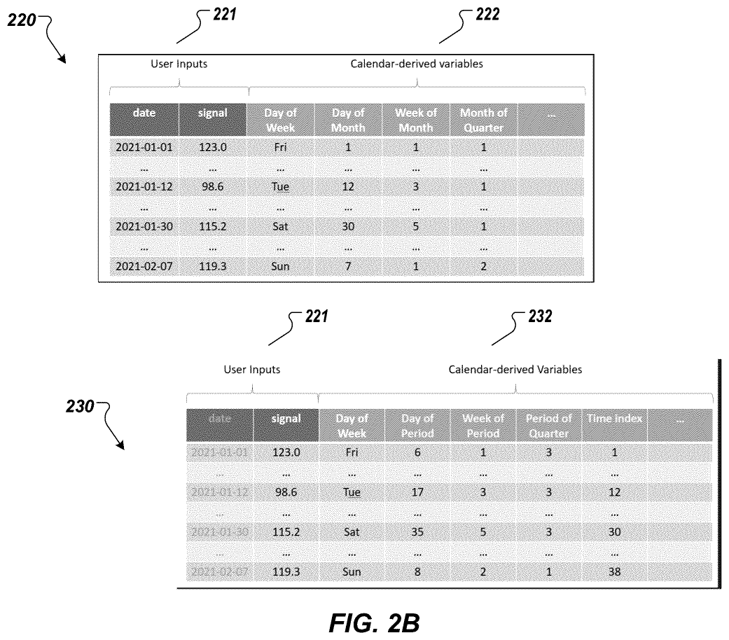

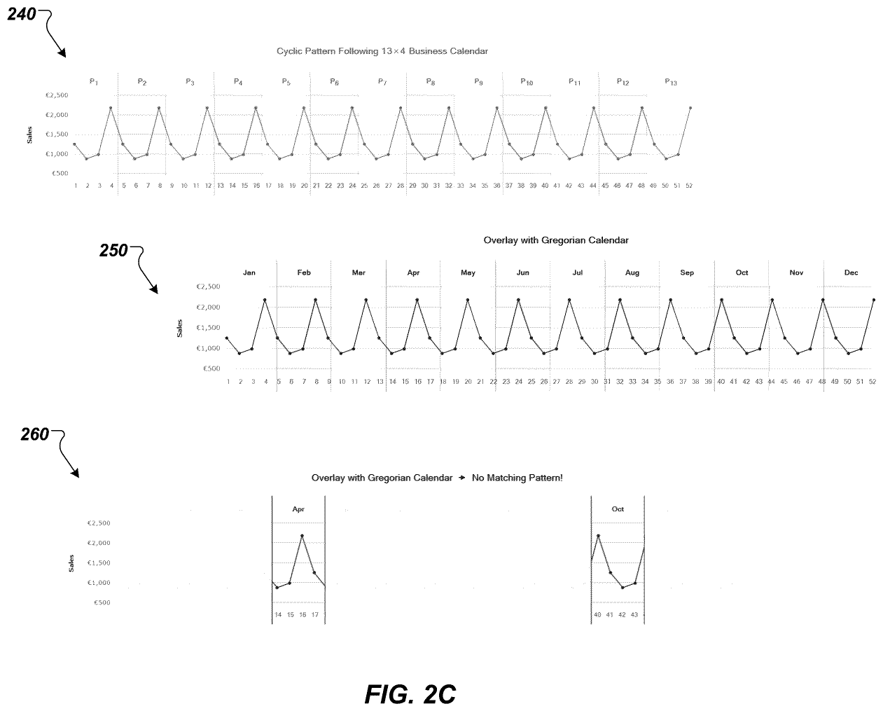

In some instances, the cloud environment 106 and/or the cloud environment 108 can provide infrastructure for executing a predictive model to predict values for a variable associated with data observation, where the predictive model is defined according to a time hierarchy of a planning calendar as further described in relation to FIGS. 2A, 2B, 2C, 3, 4, and 5.

FIG. 2A is a block diagram depicting an example 200 of a forecast resulting from a time series analysis and time hierarchy 210 that can be used for the analysis.

In some instances, time series data can be collected and analyzed to generate a time series forecasting model to support prediction. The analysis may be relying on time data as a predictor as well as on extra-predictors to generate the prediction. For example, the times series 200 includes signal data 202 and extra predictor data 204 (for example, other signal data that is collected) at different days of the year (as shown at column Date 201). The date 201 associated with the data observation for the signal can be used to generate calendar derived variables 203 (for example, indicate into which weeks of the month the date falls) and/or more extra predictors (not shown on FIG. 2A), for example, such that categorizes the date 201 as to a working day or a holiday.

In some instances, modeling techniques rely on past data collected as data observations associated with respective dates. Based on the past data, a forecast value 205 for the signal data can be provided. A prediction model can be generated to predict a signal value for a future day or over a prediction horizon (for example, a period such as a set of days (for example, a range of days defined in line with a time hierarchy of a calendar used for the forecasting)). The forecast value 205 can be generated based on the two extra predictors 203 and 204. A set of forecast values can be generated and those forecast values would be determined based on the identified data cycles in the past data observations used for the forecasting. The prediction model that is generated uses the identified recurring data patterns in the past data according to the time dimension used by the modeling technique for generating the prediction model.

In some instances, a prediction model can be generated based on collected data, such as time series 200 data. The prediction model can be generated based on a time dimension, for example, a time dimension that relies on a time hierarchy having multiple hierarchy levels representing different level of time hierarchy as shown at 210.

In some instances, a date, as stored in the column 201 of time series 200, can be mapped to time predictor values according to a time hierarchy of a planning calendar, as previously discussed. Thus, the date can be classified as an occurrence within different hierarchy levels of a time hierarchy of the planning calendar. In some instances, the time hierarchy can comprise levels with time hierarchy 210 that comprise periods of weeks as a hierarchy level. For example, in a Gregorian calendar, a period of the time hierarchy is a month, where in another calendar as the planning calendars discussed above (for example, with a 4-4-5 week-based pattern or a 5-4-4 week-based pattern), each period can be defined to comprise a number of weeks based on a week-based pattern of the planning calendar.

FIG. 2B is a block diagram depicting example model variables that can be used for generating a predictive model for prediction based on data observations, in accordance with implementations of the present disclosure.

At data 220, time series are provided as input 221 presented in a table including a time dimension (date) and a measure (signal data measurement). The data observations of the time series are mapped to calendar-derived variables 222, where each variable defines a position of the date within a hierarchy defined for the Gregorian calendar. The hierarchy can include levels of the Gregorian calendar such as a week, a month, a quarter. Thus, a date can be mapped to its position within the week (for example, Friday), to a position within a month (for example, first day of the month), to a number identifying the week of the month of the date occurrence (for example, first week), to a number identifying a month within the quarter of the year (for example first month of the quarter for January), among other possible mappings to different hierarchy levels. The user input 221 can be used to generate table 230 where variables can be derived based on a planning calendar (e.g. user-provided calendar). The calendar-derived variables 232 that are model generated variables considered to replace the “date” variable at the user input 221 as a time dimension.

In some instances, forecasting techniques can be used to be applied over the user input 221 to predict values for the signal data. When executing the forecasting techniques, a calendar can be provided (and/or calendar that is generated as a custom calendar that is provided for the forecasting) and relied upon for defining a predictive model that takes into considerations the hierarchy of the calendar of the data analysis. The selection of a calendar for the forecasting can be based on an indication of a planning calendar that is going to be used for implementing execution of actions based on the forecasting results. By executing forecasting based on such planning calendar, time patterns and/or periodicities within the signal data as data observations can be identified in accordance with periods defined in the planning calendar. For example, the planning calendar can be as discussed above, and the planning calendar can be defined according to a time hierarchy including time hierarchy 210 of FIG. 2A.

In some instances, data 230 is generated based on the data 220, where the data 230 is generated by modifying the model generated variable 222 to a non-Gregorian planning calendar 5-4-4 week-based pattern calendar. However, it can be appreciated that the data 230 can be generated for another non-Gregorian planning calendar (for example, a 5-4-4 week-based pattern calendar, 13-4 week-based pattern calendar, or other calendar). Each date from the input 221 is mapped to an occurrence within a hierarchy level defined for a time hierarchy of a non-Gregorian planning calendar. Thus, a date is mapped to a day of a week (as a lowest hierarchy level), a day of a period (a period of five or four weeks depending on the consecutive position within the period within the year), a week of a period (a number identifying the consecutive position of the week within the given period), a period of quarter (where a quarter has three periods in the 5-4-4 week-based pattern calendar). Further, the date can be mapped to other hierarchy levels defined for the non-Gregorian 5-4-4 week-based pattern planning calendar. In some instances, each time point can be mapped to a time index identifying the consecutive number of the observation as collected and used for the analysis.

In some instances, a predictive model is trained based on the calendar-derived variables 232 to predict the values for the signal (as observed at the user input 221). The model generated variable can include a time index, where each time index value is defined to correspond to a position of the observation within the list, for example, values can be rational numbers in the range [1, n]. The time index can be used to support identification of fixed length cycle patterns in the data observations for the signal 221 (as shown as column “time index” part of the calendar-derived variables in 232. The predictive model can be trained based on variables derived from the time hierarchy of the planning calendar that is provided and used for the prediction, which is in this case, the 5-4-4 week-based pattern calendar.

In some instances, the date can be mapped to a week, period, quarter, and a year. Further, the date can be mapped as a relative position of the mapped week for the date within any other hierarchy level, for example, period. For example, multiple model variables 232 can be defined, where the model variables 232 can be derived based on a planning calendar. For example, the model variables 232 can include a day of the week, a day of a period, a day of a quarter (not shown), a day of the year (not shown); a week of a period, a week of a quarter (not shown), a week of the year (not shown), a period of a quarter, a period of a year (not shown), and/or other.

In some instances, a variable can be defined for the position of the week from the end of the period, for the position of the week from the end of the year, among other example definitions for generating variables that can be related to the planning calendar and also relevant for the purposes of the execution of the predictions, for example, tracking business needs or time patterns.

FIG. 2C includes graphs as examples for comparison of executing prediction based on different calendars.

In some instances, when time series are evaluated based on a planning calendar, it may be possible to detect cyclic patterns that can recur according to the planning calendar. In such way, the prediction can be directly implemented and consumed as input for a subsequent planning activity. The planning calendar and activity can be related to the patterns of an organization and particular scheduling and organization of task execution. If different calendars are used for analyzing time series, then different patterns can be identified. However, if a pattern is identified based on a time dimension of one calendar, it may be complicated to derive how to incorporate it in a planning activity of another calendar, or it can lead to a confusion of whether there is a pattern or cycle in the data and which is the real pattern in the observed data.

In accordance with implementations of the present disclosure, prediction can be executed to align with calendars that are relevant for the data that is evaluated and/or for the particular context of the use of the data (for example, as input for another process and execution).

Diagrams 240 and 250 present time series data collected for sales over a year period. The diagrams 240 and 250 are generated for the same collected data. The diagrams 240 and 250 are different from one another based on the time dimension used. The diagram 240 relies on a particular planning calendar, that is 13×4 week-based pattern calendar, and diagram 250 relies on the Gregorian calendar. The planning calendar associated with diagram 240 defined 13 periods, each having 4 weeks, and the planning calendar associated with diagram 250 defines 52 weeks, where each period corresponds to a month of the Gregorian calendar that have varying number of days and respective varying number of weeks and in some cases a portion (s) of weeks (for example, for months with 30 and 31 days).

At diagram 240, data observations are plotted according to a 13×4 planning calendar, and cycle patterns are identified at each of the thirteen periods. In some instances, it can be determined that the time series data include a cycle pattern if there are cycles in the data detected at some but not all of the periods, for example, at a set of subsequent periods complying with a cycle identification rule.

At diagram 250, the data observations are plotted according to the Gregorian Calendar and a period of the Gregorian Calendar is a month that has a varying length (that is, January has 31 days, February has 28 days (with 29 days every fourth year), March has 31 days, and so forth).

As shown at diagram 260, that highlights the periods including April and October of the diagram 250, these two periods do not show matching patterns, thus, if the time series data is evaluated according to the Gregorian calendar, it may not be determined that the data observations for the sales follow a particular cycle (or trend) that can be used to generate the forecasts that will be provided to the processes. The forecasts executed based on prediction models defined according to a relevant calendar can be provided to a process, for example, automated execution of deliveries, scheduling, planning, among other example processes.

In contrast, when the data is evaluated according to a time dimension matching a hierarchy of a planning calendar such as the 13×4 week-based pattern planning calendar, a pattern in the sales observations is identifiable.

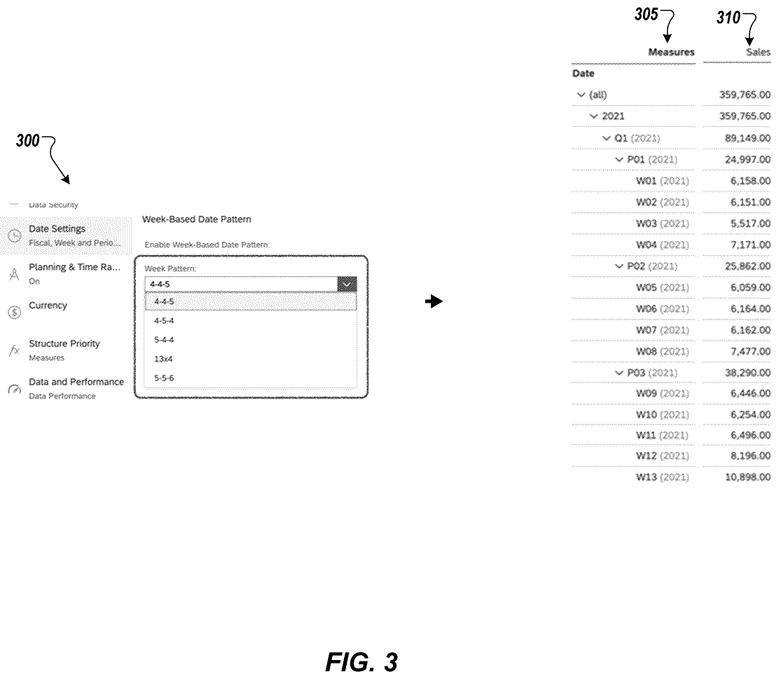

FIG. 3 is a block diagram presenting an example user interface 300 for defining a week-based pattern of a planning calendar to be used for generating a predictive model in accordance with implementations of the present disclosure.

In some instances, a predictive model can be defined based on a received request for execution of a prediction for a given variable and for a particular time horizon. As previously discussed, the predictive model can be generated with consideration of a time dimension that can match a planning calendar associated with the prediction and the observed data. For example, sales revenue from a product at a store are monitored per day and the historical data is used to predict demand for the product for the next business year of the store. In that example, the store may perform their planning for supply of good and marketing activities based on a particular planning calendar having week cycles, such as 5-4-4 week-based pattern, 4-5-4 week-based pattern, 4-4-5 week-based pattern, or another week-based pattern calendar.

In some instances, when predictive services are requests, a selection of a planning calendar relevant for the predictive model generation can be performed. The user interface 300 provides options to select planning calendars including different week patterns, such as
5-4-4 Pattern: each quarter is defined as 3 periods of 5, 4 then 4 weeks;
4-5-4 Pattern: each quarter is defined as 3 periods of 4, 5 then 4 weeks;
4-4-5 Pattern: each quarter is defined as 3 periods of 4, 4, then 5 weeks;
13×4 Pattern: the year is divided into 13 periods of 4 weeks each.

In some instances, the user interface 300 can provide options for selection of a custom pattern for the used calendar, where the user can be provided with the tools to flexibly define a time hierarchy including the week-based pattern for the calendar. We may also want to be able to leverage any user defined time dimension included in a typical planning application.

In some instances, the user interface 300 can be part of a planning application that can be used by an entity, such as an organization, to perform their planning activities based on invoking prediction logic to predict values of a predicted variable over a time horizon. The user interface 300 can allow for selection of a planning calendar, for example, selection of a planning calendar with a 4-4-5 week-based pattern. Based on a selection of such a pattern, a measure variable 310 such as sales (or sales revenue) is evaluated according to a time dimension 305 that aggregates the data based on a time hierarchy defined for the planning calendar, which includes a year (for example, 2021), a quarter (part of the year), a period (for example, three period per quarter), and a week as part of a period and defined according to a week-based pattern, so that, the first two periods of a quarter include four weeks, and the third period includes five weeks, to match the 4-4-5 week-based pattern.

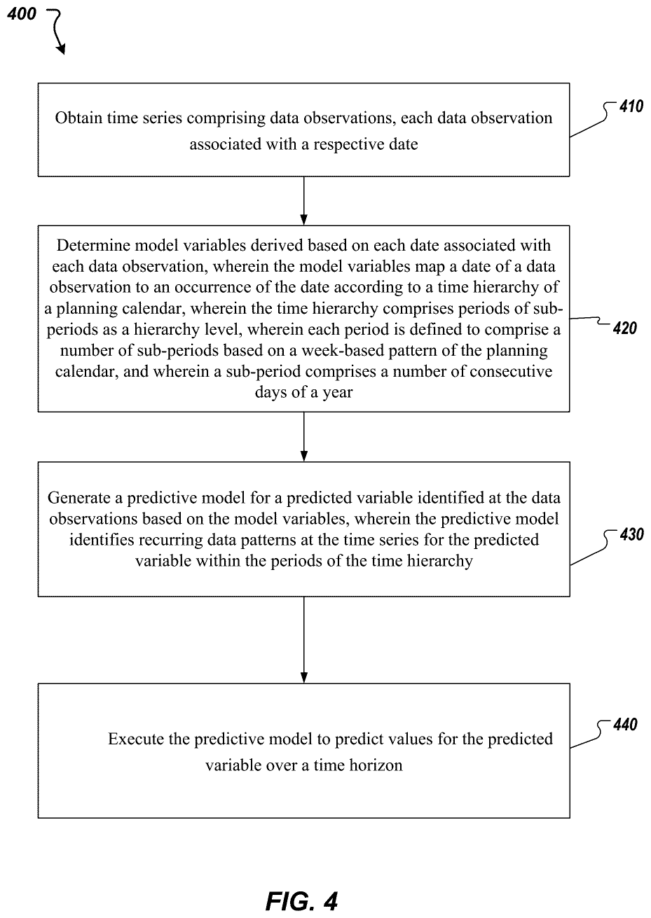

FIG. 4 is an example of a process 400 to identify recurring data patterns in time series and generate forecasts based on the identified data patterns in accordance with implementations of the present disclosure.

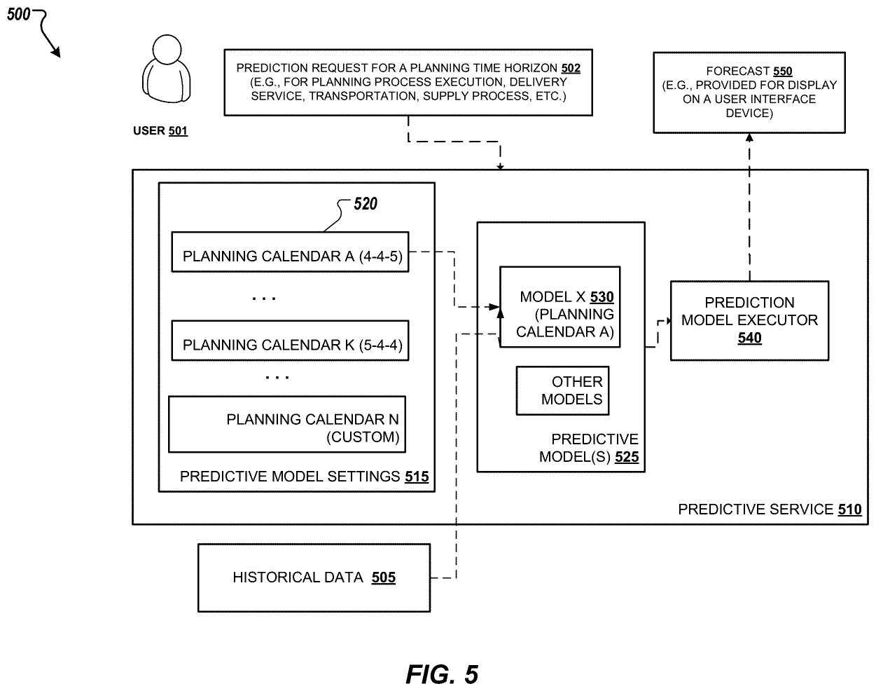

In some instances, the process 400 can be executed in the context of a prediction service provided to a planning application to define future actions for execution based on the prediction results. In some instances, the process 400 can be executed based on time series data as described in FIG. 2A and in consideration with a time dimension based on a time hierarchy of a planning calendar (for example, selected using a user interface such as the user interface 300 of FIG. 3). In some instances, the process 400 can be executed at environment 500 of FIG. 5 and as part of the logic implemented at a predictive service 510.

At 410, time series comprising data observations are obtained. For example, the time series can be such as the time series discussed at FIGS. 1, 2A, 2B, and 3. The time series include data points as data observation associated with a respective date.

In some instances, time series data can include data identifying a position of the respective date of a data observation within a hierarchy of a Gregorian calendar, wherein the Gregorian calendar is defined to comprise hierarchy levels comprising calendar year, calendar quarter, calendar month as a period comprising a respective number of days.

At 420, model variables are derived based on each date associated with each data observation. The model variables can be substantially similar to the model variable discussed at FIG. 2B and can be associated with a given planning calendar used for the prediction. The planning calendar can be one of multiple options and can be a calendar that is different from the Gregorian calendar. In some instances, the planning calendar can be provided as a selection from a set of available calendars, as presented on the user interface 300 of FIG. 3.

In some instances, the model variables map a date of a data observation to an occurrence of the data observation according to a time hierarchy of a planning calendar. The time hierarchy can include periods of sub-periods (for example, weeks) as a hierarchy level. In some instances, the time hierarchy can be based on a time hierarchy such as the time hierarchy 210 of FIG. 2A. In some instances, a time hierarchy is not limited to the time hierarchy 210 and may be defined based on period and sub-periods of different granularity including ranges of days of a year.

In some instances, each period in the time hierarchy can be defined to include a number of sub-periods based on a sub-period-based pattern of a planning calendar. For example, the time hierarchy can include weeks distributed between periods, quarters, half year, years, or other time hierarchies based on a week-based pattern of the planning calendar (for example, 4-4-5 pattern, 5-4-4 pattern, or other pattern). In a defined time hierarchy including weeks, a week can include seven consecutive days. In some instances, the week can be defined to start on the same weekday of the Gregorian calendar, for example, Monday. For example in this way, a planning calendar can include weeks and periods that differ from weeks and months defined in the Gregorian calendar (that is, where a period is considered to be a month). In some instances, a planning calendar can have definitions of each or some of the hierarchy levels of the time hierarchy that is different from the level defined in the Gregorian calendar. Thus, the planning calendar can be a calendar defined to include the same number of days in on a same hierarchy level of the time hierarchy, and each week within a period of the time hierarchy can be defined to start on the same weekday.

In some instances, the time hierarchy of a planning calendar can rely on a sub-period-based pattern that distributes the same number of sub-periods within each period, or has a varying number of sub-periods within each period. In some instances, in a time hierarchy relying on a week-based pattern that does not include the same number of weeks per period, a first period of weeks within the time hierarchy of the planning calendar can include a different number of weeks compared to a second period of weeks and a third period of weeks, the second period and the third period being defined within the time hierarchy of the planning calendar. For example, a planning calendar with 4-4-5 week-based pattern is an example of a calendar with such a time hierarchy with uneven distribution of weeks per period pattern. In some instances, the planning calendar can comprise the same number of weeks for a period. For example, a planning calendar with 13×4 week-based pattern is an example of a calendar with such even distributions of weeks per period pattern (13 period including 4 weeks each), but with a different number of weeks per quarter.

In some instances, the model variables are determined for each hierarchy level of the planning calendar (comprising a year, a quarter, a period, a week, and a day) and for combination of hierarchy level (for example “PeriodOfQuarter” is defined as a combination of “Period” and “Quarter”).

At 430, a predictive model is generated for a predicted variable determined from the data observations based on the model variables for prediction. For example, the predictive model can be to forecast the signal data, based on generated variables as presented in data 230 of FIG. 2B, or for sales data as discussed in relation to FIG. 3.

In some instances, the predictive model identifies recurring data patterns in the time series for the predicted variable within the periods of the time hierarchy.

At 440, the predictive model is executed to predict values for the predicted variable over a time horizon, for example, defined according to the time hierarchy of the planning calendar or another time hierarchy of another planning calendar.

In some instances, the predicted values for the predicted variable can be provided as input for executing a process for scheduling resource consumption over the time horizon. For example, if the predicted variable is sales, a marketing campaign can be initiated and marketing activities can be generated around data cycles identified for the predicted sales according to the planning calendar (for example, a marketing planning calendar for organizing sales, promotions, stock maintenance, delivery, or other processes).

In some instances, the predictive model is generated based on a plurality of predictor values including the model variable as one or more additional variable(s) that are determined as a predictor(s) to support the prediction of values for the predicted variable. For example, the data 200 of FIG. 2A includes multiple predictors as variables to be used for generating a prediction (or a forecast).

FIG. 5 is a block diagram of a system environment 500 for executing prediction services based on a time horizon defined according to a calendar in accordance with implementations of the present disclosure. The system environment can be a cloud or on-premise environment supporting execution of prediction services and providing forecasts to be integrated in organizational maintenance and planning processes.

In some instances, a predictive service 510 can be provided, for example, as a platform service or an application in a cloud or on-premise context, for execution of predictions based on historical data 505, where a planning calendar is selected for executing the predictions. For example, the planning calendar can be selected to match a particular organizational calendar used for generating a predictive model. The time hierarchy of the planning calendar can be considered to generate additional variables for determining data cycles in the data observations of the historical data.

In some instances, the predictive service 510 provides predictive model settings 515 that can support the selection of settings for a planning calendar that can be used for generating one or more predictive model(s) 525 based on time series data from the historical data 505. The predictive model settings 515 can be provided for selection through a user interface that can be accessible for a user, such as user 501.

In some instances, the user 501 can send a prediction request 502 for a obtaining a forecast for a measure (for example, sales prediction, signal prediction, resource consumption prediction, process execution result prediction, quality assurance results, or others). The prediction request can define a planning time horizon for the prediction result, where the planning time horizon can be aligned with a process that may consume the output of the prediction, for example, for planning process execution, delivery service planning, transportation, supply processes, other.

In some instances, after the user 501 had requested a prediction at 502, the user 501 may provide (e.g., through selection or received directly with the data) a planning calendar, for example from the available planning calendars as defined at the predictive model settings 515 that can include predefined planning calendars and custom-made planning calendars that can be defined based on input from the user 501. In some instances, a prediction model can be generated based on a selection of a planning calendar. For example, model X 530 can be generated based on a planning calendar A 520 (that is, defined according to a 4-4-5 week-based pattern). The model X 530 can be generated in accordance with implementations of the present disclosure, and for example, as described in relation to process 400 of FIG. 4.

In some instances, a predictive model from the generated predictive model settings 515 can be executed to predict values for a predicted variable over a time horizon, as requested. The time horizon can be defined according to a respective time hierarchy of a respective planning calendar used for generating the respective predictive model that is to be executed. In some instances, the model X 530 can be executed by a predictor model executor 540 and a forecast 550 can be generated. The generated forecast 550 can be provided for display on a user interface device.

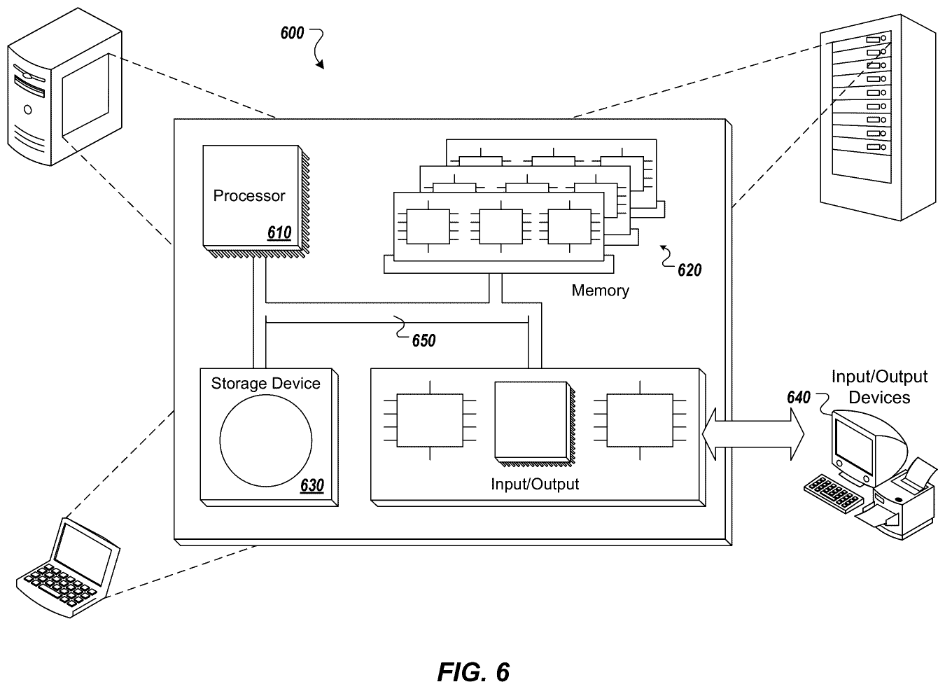

FIG. 6 is a schematic diagram of an example computer system 600 that can be used to execute implementations of the present disclosure. For example, the computer system 600 may be included in any or all of the server components discussed herein. The computer system 600 includes a processor 610, a memory 620, a storage device 630, and an input/output device 640. The components 610, 620, 630, and 640 are interconnected using a system bus 650. The processor 610 is capable of processing instructions for execution within the computer system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the computer system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the computer system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or combinations of them. The apparatus can be implemented in a computer program product tangibly embodied in an information carrier (for example, in a machine-readable storage device, for execution by a programmable processor), and method operations can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or another unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory, or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a cathode ray tube (CRT) or liquid crystal display (LCD) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship between client and server arises by virtue of computer programs running on the respective computers and having a client-server relationship with each other.

In addition, the logic flows depicted in the figures do not require the particular order shown, or sequential order, to achieve desirable results. In addition, other operations may be provided, or operations may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

In view of the above described implementations of subject matter, this application discloses the following list of examples, wherein one feature of an example in isolation or more than one feature of said example taken in combination and, optionally, in combination with one or more features of one or more further examples are further examples also falling within the disclosure of this application.

### Examples

Although the present application is defined in the attached claims, it should be understood that the present invention can also be (alternatively) defined in accordance with the following examples:

Example 1. A computer-implemented method, comprising:
obtaining, as an obtained time series, a time series comprising data observations, each data observation associated with a respective date;
determining model variables derived based on each date associated with each data observation, wherein the model variables map a date of a data observation to an occurrence of the date according to a time hierarchy of a planning calendar, wherein the time hierarchy comprises periods of sub-periods as a hierarchy level, wherein each period is defined to comprise a number of sub-periods based on a week-based pattern of the planning calendar, and wherein a sub-period comprises a number of consecutive days of a year;
generating a predictive model for a predicted variable identified at the data observations based on the model variables, wherein the predictive model identifies recurring data patterns at the time series for the predicted variable within the periods of the time hierarchy; and executing the predictive model to predict, as predicted values, values for the predicted variable over a time horizon.

Example 2: The computer-implemented method of Example 1, wherein the model variables are determined for each combination of hierarchy levels of the planning calendar, the hierarchy levels comprising a year, an aggregation period, a period, a sub-period, and a day.

Example 3: The computer-implemented method of claim 1, wherein the planning calendar is a calendar defined to comprise a same number of days in a hierarchy level of the time hierarchy, and wherein each sub-period within a period of the time hierarchy is defined to start on a same weekday of the Gregorian calendar.

Example 4: The computer-implemented method of any of the preceding Examples, wherein a first period of sub-periods is a period of weeks within the time hierarchy of the planning calendar, wherein the first period comprises a different number of weeks compared to a second period of weeks as sub-periods and a third period of weeks as sub-periods, the second period of weeks and the third period of weeks being defined within the time hierarchy of the planning calendar.

Example 5: The computer-implemented method of any of the preceding Examples, wherein the planning calendar comprising a 4-4-5 week-based pattern as the pattern of the planning calendar, wherein the 4-4-5 week-based pattern defines a repetitive sequence of number of weeks for each consecutive period in the time hierarchy of the planning calendar.

Example 6: The computer-implemented method of any of the preceding Examples, wherein each period of sub-periods comprises a same number of sub-periods as the week-based pattern of the planning calendar.

Example 7: The computer-implemented method of any of the preceding Examples, wherein the obtained time series comprise data identifying a position of a respective date of a data observation within a hierarchy of a Gregorian calendar, wherein the Gregorian calendar is defined to comprise hierarchy levels comprising calendar year, calendar quarter, calendar month as a period comprising a respective number of days.

Example 8: The computer-implemented method of any of the preceding Examples, comprising:

providing the predicted values for the predicted variable as input for executing a process for scheduling resource consumption over the time horizon.

Example 9: The computer-implemented method of any of the preceding Examples, wherein the predictive model is generated based on a plurality of predictor values comprising the model variables as variables for prediction and one or more additional variables as one or more respective predictors to support prediction of values for the predicted variable.

Example 10: A system comprising:
one or more processors; and
one or more computer-readable memories coupled to the one or more processors and having instructions stored thereon that are executable by the one or more processors to perform the method of any of Examples 1 to 9.

Example 11: A non-transitory, computer-readable medium coupled to one or more processors and having instructions stored thereon which, when executed by the one or more processors, cause the one or more processors to perform the method of any of Examples 1 to 9.

What is claimed is:

1. A computer-implemented method, comprising:
obtaining, as an obtained time series, a time series comprising data observations, each data observation associated with a respective date;
determining model variables derived based on each date associated with each data observation, wherein the model variables map a date of a data observation to an occurrence of the date according to a time hierarchy of a planning calendar, wherein the time hierarchy comprises periods of sub-periods as a hierarchy level, wherein each period is defined to comprise a number of sub-periods based on a week-based pattern of the planning calendar, and wherein a sub-period comprises a number of consecutive days of a year;
generating a predictive model for a predicted variable identified at the data observations based on the model variables, wherein the predictive model identifies recurring data patterns at the time series for the predicted variable within the periods of the time hierarchy; and
executing the predictive model to predict, as predicted values, values for the predicted variable over a time horizon.

2. The computer-implemented method of claim 1, wherein the model variables are determined for each combination of hierarchy levels of the planning calendar, the hierarchy levels comprising a year, an aggregation period, a period, a sub-period, and a day.

3. The computer-implemented method of claim 1, wherein the planning calendar is a calendar defined to comprise a same number of days in a hierarchy level of the time hierarchy, and wherein each sub-period within a period of the time hierarchy is defined to start on a same weekday of the Gregorian calendar.

4. The computer-implemented method of claim 1, wherein a first period of sub-periods is a period of weeks within the time hierarchy of the planning calendar, wherein the first period comprises a different number of weeks compared to a second period of weeks as sub-periods and a third period of weeks as sub-periods, the second period of weeks and the third period of weeks being defined within the time hierarchy of the planning calendar.

5. The computer-implemented method of claim 1, wherein the planning calendar comprising a 4-4-5 week-based pattern as the pattern of the planning calendar, wherein the 4-4-5 week-based pattern defines a repetitive sequence of number of weeks for each consecutive period in the time hierarchy of the planning calendar.

6. The computer-implemented method of claim 1, wherein each period of sub-periods comprises a same number of sub-periods as the week-based pattern of the planning calendar.

7. The computer-implemented method of claim 1, wherein the obtained time series comprise data identifying a position of a respective date of a data observation within a hierarchy of a Gregorian calendar, wherein the Gregorian calendar is defined to comprise hierarchy levels comprising calendar year, calendar quarter, calendar month as a period comprising a respective number of days.

8. The computer-implemented method of claim 1, comprising:
providing the predicted values for the predicted variable as input for executing a process for scheduling resource consumption over the time horizon.

9. The computer-implemented method of claim 1, wherein the predictive model is generated based on a plurality of predictor values comprising the model variables as variables for prediction and one or more additional variables as one or more respective predictors to support prediction of values for the predicted variable.

10. A non-transitory, computer-readable medium coupled to one or more processors and having instructions stored thereon which, when executed by the one or more processors, cause the one or more processors to perform operations comprising:
obtaining, as an obtained time series, a time series comprising data observations, each data observation associated with a respective date;
determining model variables derived based on each date associated with each data observation, wherein the model variables map a date of a data observation to an occurrence of the date according to a time hierarchy of a planning calendar, wherein the time hierarchy comprises periods of sub-periods as a hierarchy level, wherein each period is defined to comprise a number of sub-periods based on a week-based pattern of the planning calendar, and wherein a sub-period comprises a number of consecutive days of a year;
generating a predictive model for a predicted variable identified at the data observations based on the model variables, wherein the predictive model identifies recurring data patterns at the time series for the predicted variable within the periods of the time hierarchy; and
executing the predictive model to predict, as predicted values, values for the predicted variable over a time horizon.

11. The non-transitory, computer-readable medium of claim 10, wherein the model variables are determined for each combination of hierarchy levels of the planning calendar, the hierarchy levels comprising a year, an aggregation period, a period, a sub-period, and a day.

12. The non-transitory, computer-readable medium of claim 10, wherein the planning calendar is a calendar defined to comprise a same number of days in a hierarchy level of the time hierarchy, and wherein each sub-period within a period of the time hierarchy is defined to start on a same weekday of the Gregorian calendar.

13. The non-transitory, computer-readable medium of claim 10, wherein a first period of sub-periods is a period of weeks within the time hierarchy of the planning calendar, wherein the first period comprises a different number of weeks compared to a second period of weeks as sub-periods and a third period of weeks as sub-periods, the second period of weeks and the third period of weeks being defined within the time hierarchy of the planning calendar.

14. The non-transitory, computer-readable medium of claim 10, wherein the planning calendar comprising a 4-4-5 week-based pattern as the pattern of the planning calendar, wherein the 4-4-5 week-based pattern defines a repetitive sequence of number of weeks for each consecutive period in the time hierarchy of the planning calendar.

15. The non-transitory, computer-readable medium of claim 10, wherein each period of sub-periods comprises a same number of sub-periods as the week-based pattern of the planning calendar.

16. A computer-implemented system comprising:
one or more processors; and
one or more computer-readable memories coupled to the one or more processors and having instructions stored thereon that are executable by the one or more processors to perform operations comprising:
obtaining, as an obtained time series, a time series comprising data observations, each data observation associated with a respective date;
determining model variables derived based on each date associated with each data observation, wherein the model variables map a date of a data observation to an occurrence of the date according to a time hierarchy of a planning calendar, wherein the time hierarchy comprises periods of sub-periods as a hierarchy level, wherein each period is defined to comprise a number of sub-periods based on a week-based pattern of the planning calendar, and wherein a sub-period comprises a number of consecutive days of a year;
generating a predictive model for a predicted variable identified at the data observations based on the model variables, wherein the predictive model identifies recurring data patterns at the time series for the predicted variable within the periods of the time hierarchy; and
executing the predictive model to predict, as predicted values, values for the predicted variable over a time horizon.

17. The system of claim 16, wherein the model variables are determined for each combination of hierarchy levels of the planning calendar, the hierarchy levels comprising a year, an aggregation period, a period, a sub-period, and a day.

18. The system of claim 16, wherein the planning calendar is a calendar defined to comprise a same number of days in a hierarchy level of the time hierarchy, and wherein each sub-period within a period of the time hierarchy is defined to start on a same weekday of the Gregorian calendar.

19. The system of claim 16, wherein a first period of sub-periods is a period of weeks within the time hierarchy of the planning calendar, wherein the first period comprises a different number of weeks compared to a second period of weeks as sub-periods and a third period of weeks as sub-periods, the second period of weeks and the third period of weeks being defined within the time hierarchy of the planning calendar.

20. The system of claim 16, wherein the planning calendar comprising a 4-4-5 week-based pattern as the pattern of the planning calendar, wherein the 4-4-5 week-based pattern defines a repetitive sequence of number of weeks for each consecutive period in the time hierarchy of the planning calendar.
